(19) United States
(12) Patent Application Publication
(10) Pub. No.: US 2025/0285784 A1
(43) Pub. Date: Sep. 11, 2025

(54) INSULATED WIRE AND STRUCTURE USING THE SAME

(71) Applicant: Proterial, Ltd., Tokyo (JP)

(72) Inventors: Tetsuro SATO, Tokyo (JP); Satoru OUCHI, Tokyo (JP); Kentaro ABE, Tokyo (JP)

(21) Appl. No.: 19/066,541

(22) Filed: Feb. 28, 2025

(30) Foreign Application Priority Data
Mar. 5, 2024 (JP) 2024-032950

(51) Int. Cl. H01B 3/30

(52) U.S. Cl. CPC H01B 3/302

(57) ABSTRACT

An insulated wire includes a linear conductor insulative coated with an insulator made of thermoplastic polyurethane as an outermost layer, and a plurality of wavy irregularities provided on a surface of the insulator along a direction perpendicular to a longitudinal direction of the insulated wire, and an arithmetic mean height Sa of the surface of the insulator is 4.4 μm or more and 12 μm or less. A structure includes the insulated wire and a component made of ethylene propylene rubber, bonded to the surface of the insulator of the insulated wire by an adhesive.

### CROSS-REFERENCE TO RELATED APPLICATIONS

The present patent application claims the priority of Japanese patent application No. 2024-032950 filed on Mar. 5, 2024, the entire contents of which are incorporated herein by reference.

### TECHNICAL FIELD

This invention relates to an insulated wire (insulated electric wire) and a structure using the same.

### BACKGROUND OF THE INVENTION

Conventionally, molded electric wires are known in which an insulator made of thermoplastic polyurethane covering an outer circumference of a conductor wire has a predetermined surface roughness, and terminals of the insulator are covered with mold resin molded body (see Patent Literature 1).

In the molded electric wires of Patent Literature 1, the surface roughness of the insulator is adjusted to a predetermined range to improve the adhesion between the insulator and the mold resin molded body, thereby improving the airtightness of the interior of the mold resin molded body.

### PRIOR ART LITERATURE

Citation List Patent Literature 1: JP2016-162566A

### SUMMARY OF THE INVENTION

Patent Literature 1 discloses a range of arithmetic mean roughness Ra that can improve the adhesion between an insulator and a mold resin molded body. The inventors of the present application have conducted research, believing that if the surface condition of an insulator suitable for adhesion using an adhesive can be achieved in the same way that the adhesion between the insulator and the mold resin molded body can be improved by the technology of Patent Literature 1, an ideal adhesion (bonding) condition can be obtained in the adhesion between the insulator and other parts, etc.

The object of the present invention is to provide an insulated wire with an insulator made of thermoplastic polyurethane as an outermost layer, which can achieve a good bonding condition with high peel strength in bonding using an adhesive, and a structure in which the insulated wire and other components are bonded by the adhesive.

For solving the aforementioned problem, one aspect of the present invention provides.

### Advantageous Effects of the Invention

According to the present invention, it is possible to provide an insulated wire with an insulator made of thermoplastic polyurethane as an outermost layer, which can achieve a good bonding condition with high peel strength in bonding using an adhesive, and a structure in which the insulated wire and other components are bonded by the adhesive.

### BRIEF DESCRIPTION OF THE DRAWINGS

FIG. 1 is a radial cross-sectional view of a cable, which is an example of an insulated wire in an embodiment of the present invention.

FIG. 2 is a cross-sectional view of an example of the structure of a pinching detection device including the cable in the embodiment of the present invention.

FIG. 3A is a photograph showing the appearance of the cable, and FIG. 3B is a laser microscopic image of a sheath surface.

FIG. 4 is a table showing the observed images of the sheath surface and various parameters of surface roughness for each extrusion temperature during sheath extrusion.

FIG. 5 is a table showing the observed images of the sheath surface and various parameters of surface roughness for each extrusion temperature during sheath extrusion.

FIG. 6 is a schematic diagram showing the shear peel test method.

FIG. 7 is a graph showing the relationship between the arithmetic mean height Sa of the sheath surface and the peel strength obtained by the cable peel test.

FIG. 8A is a scanning electron microscope (SEM) image of a sheath surface after a cable with an arithmetic mean height Sa of 1 μm on the sheath surface has been stripped from a protector.

FIG. 8B is an SEM image of a sheath surface after a cable with an arithmetic mean height Sa of 10 μm on the sheath surface has been stripped from a protector.

### DETAILED DESCRIPTION OF THE INVENTION

An insulated wire (insulated electric wire) in an embodiment of the present invention is an insulated wire including a linear conductor that is insulative-coated and has an insulator made of thermoplastic polyurethane as an outermost layer, and a plurality of wavy irregularities (i.e., wavy-line convexities, corrugated convexities) are provided on a surface of the insulator along a direction perpendicular to a longitudinal direction of the insulated wire and an arithmetic mean height Sa of the surface of the insulator is 4.4 μm or more and 12 μm or less.

The insulated wire shall also include a cable with a sheath. In this case, the sheath corresponds to the insulator as the outermost layer.

The insulator as the outermost layer (i.e., the outermost insulator) is formed by extrusion coating of thermoplastic polyurethane. Known extrusion coating methods using an extruder can be used for this extrusion coating.

For example, polyester polyurethane (adipate, cabrolactone, or polycarbonate) and polyether polyurethane can be used for the thermoplastic polyurethane that constitutes the outermost insulator. In particular, polyether polyurethane is preferred from the viewpoint of moisture and heat resistance, etc.

Additives such as processing aids, flame retardant agents, flame retardant aids, cross-linking agents, cross-linking aids, antioxidants, UV absorbers, copper damage inhibitors, lubricants, inorganic fillers, adhesion agents, stabilizers, carbon black, and colorants may be added to thermoplastic polyurethane, as needed.

The wavy irregularities on the surface of the outermost insulator improve the slipperiness of the surface and facilitate wiring of the insulated wire. In addition, the wavy irregularities on the surface of the outermost insulator improves the peeling strength of the insulated wire when it is bonded to other parts, etc. with an adhesive. This is because the adhesive applied to the surface of the outermost insulator penetrates into the wavy irregularities and hardens, creating an anchor effect.

When the wavy irregularities on the surface of the insulator is large enough that the arithmetic mean height Sa of the surface of the insulator is 4.4 μm or more, a good bonding condition with high peeling strength can be obtained.

In order to further increase the peel strength, it is preferable that the wavy irregularities be large enough to have an arithmetic mean height Sa of 5.8 μm or more. Furthermore, in order to obtain an ideal bonding condition where material breakdown occurs upon peeling, it is more preferable that the wavy irregularities be large enough to have an arithmetic mean height Sa of 10 μm or more. Here, the relationship between the arithmetic mean height Sa of the surface of these insulators and the peeling strength after bonding is valid when the insulated wire has a certain size (for example, 1 mm or more in diameter).

On the other hand, the larger the wavy irregularity, the thicker the layer of applied adhesive becomes, which increases the time required for the adhesive to cure. For example, when using adhesives such as cyanoacrylate adhesives, which cure by polymerization of molecules reacting with moisture in the air, the thicker the layer of adhesive, the slower the reaction with water becomes and the longer the curing time.

Therefore, the curing time of the adhesive can be kept within a practical range by suppressing the size of the wavy irregularities to the extent that the arithmetic mean height Sa of the insulator surface is 12 μm or less.

The size of the wavy irregularities can be controlled by extrusion conditions such as extrusion temperature and extrusion speed when extrusion coating the insulator. For example, by lowering the extrusion temperature or increasing the extrusion speed, the wavy irregularities can be made larger (rougher surface).

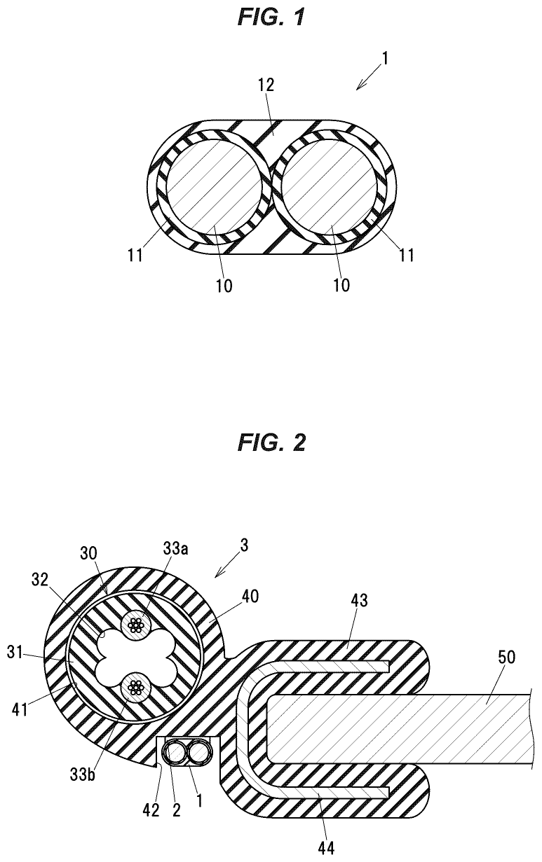

FIG. 1 is a cross-sectional view in the radial direction showing a cable 1, which is an example of an insulated wire in the embodiment of the present invention. The cable 1 has two linear conductors 10, each covered by an insulator 11, and a sheath 12 covering the two linear conductors 10 with the insulators 11.

The conductor 10 comprises, for example, a stranded linear conductor composed of a plurality of strands of copper, copper alloy, or the like twisted together. The insulator 11 is made of an insulating material such as, for example, thermoplastic polyolefin. The sheath 12 is made of thermoplastic polyurethane and constitutes the outermost insulator in the cable 1. The sheath 12 is formed by extrusion coating thermoplastic polyurethane around the two linear conductors 10, each covered by the insulator 11.

The cable 1 is used, for example, as a lead wire connected to a cable-like pressure-sensitive sensor used in an electric sliding door of a vehicle or a pinching detection device installed in an electric back door. In this case, the cable 1 is bonded to a protector that houses the cable-like pressure-sensitive sensor.

FIG. 2 is a cross-sectional view of an example of the structure of a pinching detection device 3 including the cable 1 as an example of application of the cable 1. The pinching detection device 3 has a cable-like pressure-sensitive sensor 30, a cable 1 as a lead wire connected to the pressure-sensitive sensor 30, and a protector 40 made of ethylene propylene rubber (EPDM) or the like that houses the pressure-sensitive sensor 30 and the cable 1.

The pressure-sensitive sensor 30 is housed in a housing hole 41 of the protector 40 and the cable 1 is housed in a housing groove 42 of the protector 40. The protector 40 is secured to a plate portion 50, such as a bracket on a vehicle-side, by means of a mounting portion 43 in which a metallic core 44 is embedded.

The pressure-sensitive sensor 30 has an insulator 31 with a hollow section 32 and electrode wires 33a, 33b, each coated with electrically conductive rubber. The electrode wires 33a, 33b are adhered to the inner circumference of the insulator 31 and are arranged in a spiral shape along the hollow section 32 in a state where the electrode wires 33a, 33b are spaced apart by the hollow section 32 therebetween.

In the pinching detection device 3, when the insulator 31 is deformed by an external force and the electrode wires 33a, 33b come into contact and conduct with each other, a current detection element connected to a circuit including the pressure-sensitive sensor 30 and the cable 1 detects a change in current value. Thereby, the fact that electrode wire 33a and the electrode wire 33b come into contact, i.e., that a pinching has occurred in the electric sliding door or electric back door to which the pinching detection device 3 is attached, is detected.

The cable 1 is bonded to the inner surface of the housing groove 42 with an adhesive 2 such as cyanoacrylate adhesive. As shown in this example of the pinching detection device 3, the cable 1 can achieve a good bonding condition with high peel strength when bonded to parts made of ethylene-propylene rubber.

In other words, according to the present embodiment of the invention, it is possible to provide a structure comprising the insulated electric wire in the present embodiment of the invention, such as the cable 1, and a component made of ethylene propylene rubber, which is bonded by an adhesive to the surface of the outermost insulator of the insulated wire, such as the sheath 12. In this structure, the insulated wire and the component are fixed in a good bonding condition with high peel strength.

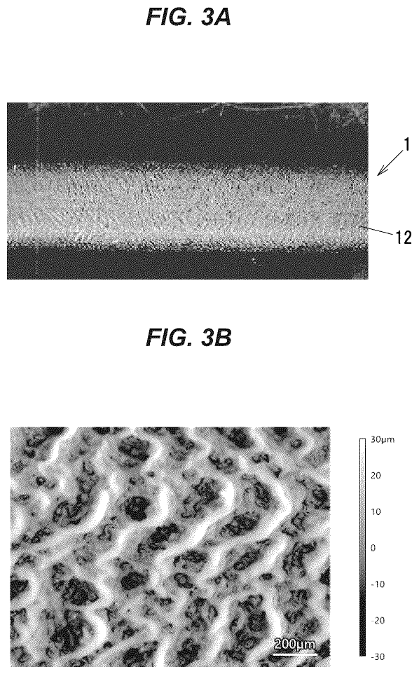

FIG. 3A is a photograph of the appearance of the cable 1, and FIG. 3B is a laser microscopic observed image of the surface of the sheath 12. In the observed image in FIG. 3B, each pixel has a color according to its height (position perpendicular to the paper surface in FIG. 3B), indicated by the bar color palette on the right. The orientation of the cable 1 in FIGS. 3A and 3B is the same. That is, the horizontal direction in FIGS. 3A and 3B roughly corresponds to the longitudinal direction of the cable 1.

According to the observed image in FIG. 3b, it can be confirmed that the surface of the sheath 12 is provided with a plurality of wavy irregularities along the direction perpendicular to the longitudinal direction of the cable 1. Note that “along the direction perpendicular to the longitudinal direction of the cable 1” does not mean a state of being strictly parallel to the direction perpendicular to the longitudinal direction of the cable 1, but rather a state to the extent that the average direction in which the plurality of wavy irregularities extend is clearly closer to the direction perpendicular to the longitudinal direction of the cable 1 than to the longitudinal direction of the cable 1.

The plurality of wavy irregularities extend along the direction perpendicular to the longitudinal direction of the cable 1 due to the plurality of wavy irregularities being formed during the extrusion coating of the sheath 12. During the extrusion process, the surface of the sheath 12 is subjected to a force along the extrusion direction, i.e., the longitudinal direction of the cable 1, resulting in wavy irregularities whose amplitude direction is along the longitudinal direction of the cable 1.

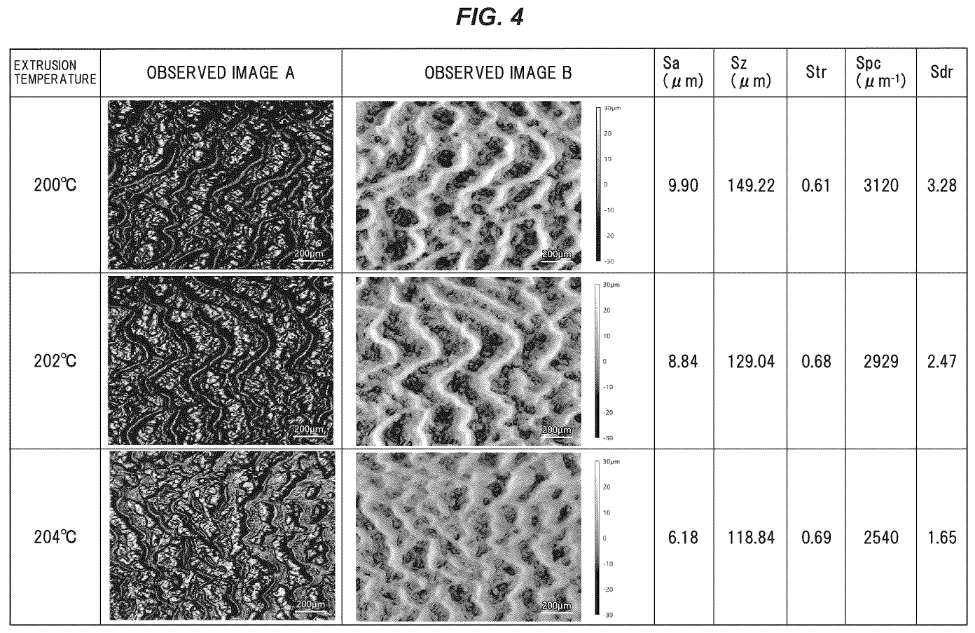

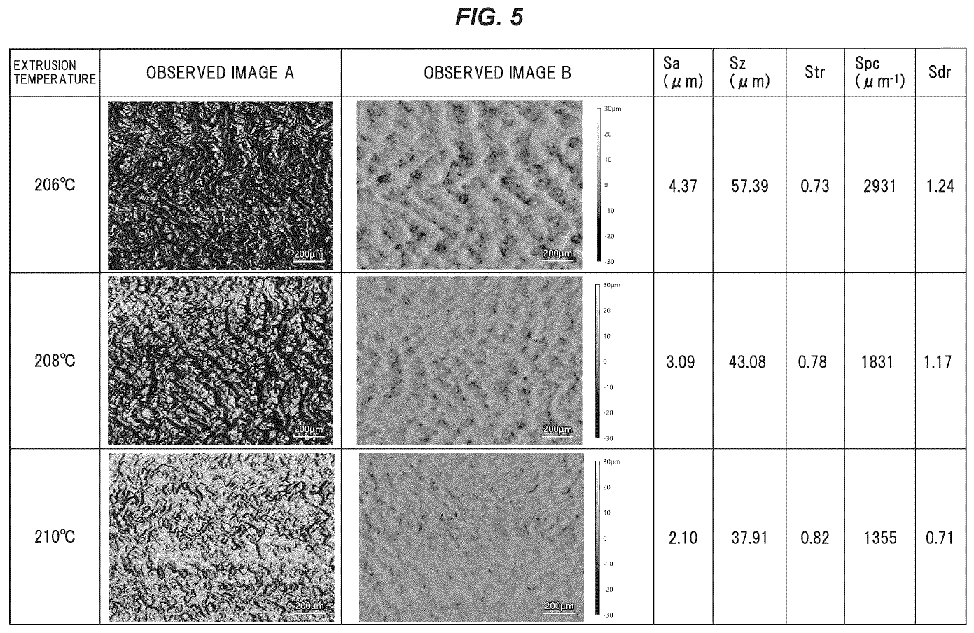

FIGS. 4 and 5 show the evaluation results of several sheaths 12 extrusion coated at the same extrusion speed (40 mm/min) and different extrusion temperatures. FIGS. 4 and 5 are tables showing the observed images of the surface of the sheath 12 and various parameters of the surface roughness according to ISO 25178 (arithmetic mean height Sa, maximum height Sz, aspect ratio Str of the surface properties, arithmetic mean curvature Spc of the peak point, and developed area ratio Sdr of the interface) for each extrusion temperature during extrusion of the sheath 12.

Observed image A in FIGS. 4 and 5 is a laser microscope image of the surface of the sheath 12, and observed image B is an observed image that includes height information for each position. In the observed image B, each pixel has a color corresponding to its height (position perpendicular to the paper surface in FIGS. 4 and 5), indicated by the bar color palette on the right.

The relationship between extrusion temperature and various parameters of surface roughness shown in FIGS. 4 and 5 indicates that the higher the extrusion temperature, the lower the surface roughness, i.e., the smaller the wavy irregularities.

The following describes the method and results of the shear peel test conducted to examine the adhesion of the surface of the sheath 12 of the cable 1.

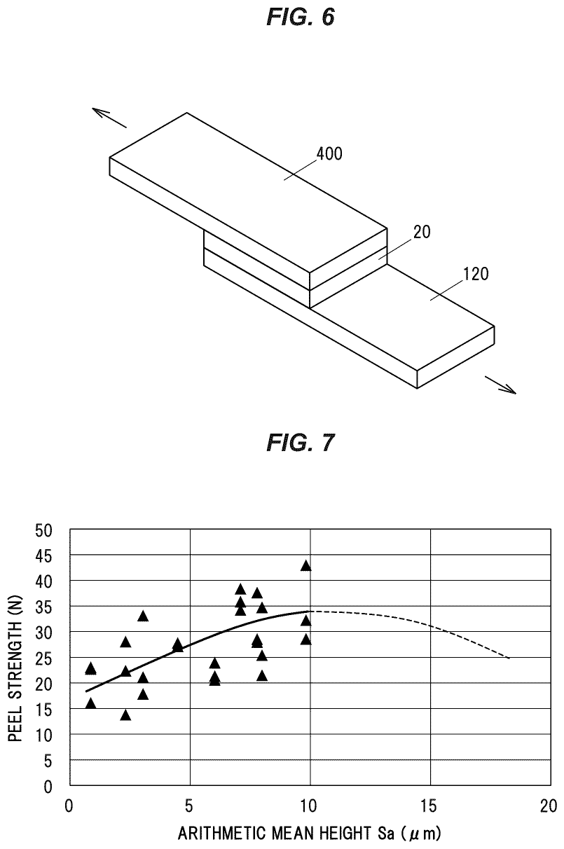

FIG. 6 is a schematic diagram of this shear peel test method. In this shear peel test, a sheet 120 made of thermoplastic polyurethane, 150 mm long×6 mm wide×3 mm thick, and a sheet 400 made of ethylene propylene rubber, 150 mm long×6 mm wide×2 mm thick, were prepared by cutting a strip of a sheath 12 peeled from a cable 1.

Then, as shown in FIG. 6, the sheets 120 and 400 were bonded together via cyanoacrylate adhesive 20, and force was applied in the direction of their thicknesses for 1 second to bond them (the bonding area is 60 mm long×6 mm wide) to produce the sample.

After bonding, a shear peel test was performed on the obtained samples to measure the peel strength. In this shear peel test, the sheet 120 and the sheet 400 were pulled in the direction indicated by the arrow in FIG. 6 at a tensile speed of 100 mm/min.

FIG. 7 is a graph showing the relationship between the arithmetic mean height Sa of the surface of the sheath 12 and the peel strength obtained from this shear peel test.

The solid line in the graph in FIG. 7 shows the relationship between the arithmetic mean height Sa and the average peel strength for arithmetic mean height Sa up to 10 μm, and the dotted line shows the relationship between the arithmetic mean height Sa and the average peel strength for arithmetic mean height Sa exceeding 10 μm.

FIG. 7 shows that the peel strength increases as the arithmetic mean height Sa increases up to approximately 10 μm. FIG. 7 also shows that when the arithmetic mean height Sa is 4.4 μm or more, the average peel strength is desirable, approximately 25 N or higher, and when the arithmetic mean height Sa is 5.8 μm or more, the average peel strength is even higher, approximately 30 N or higher. The reason why the peel strength decreases as the arithmetic mean height Sa increases in the range where the arithmetic mean height Sa exceeds 10 μm is because as the arithmetic mean height Sa increases, the reaction with water slows down due to the thicker adhesive layer, and the curing speed of the adhesive decreases.

As shown in FIG. 7, the larger the arithmetic mean height Sa of the surface of the sheath 12, the greater the peel strength of the interface between the sheath 12 and the fully cured adhesive because of the greater anchoring effect. When the arithmetic mean height Sa is 10 μm or more, an ideal bonding condition can be obtained such that material breakdown occurs during peeling.

On the other hand, the larger the arithmetic mean height Sa of the surface of the sheath 12, the thicker the adhesive layer becomes, which slows down the reaction with water and reduces the curing speed of the adhesive. In this peel test, when the arithmetic mean height Sa was greater than approximately 12 μm, peeling occurred while the adhesive was uncured, thereby reducing the peel strength.

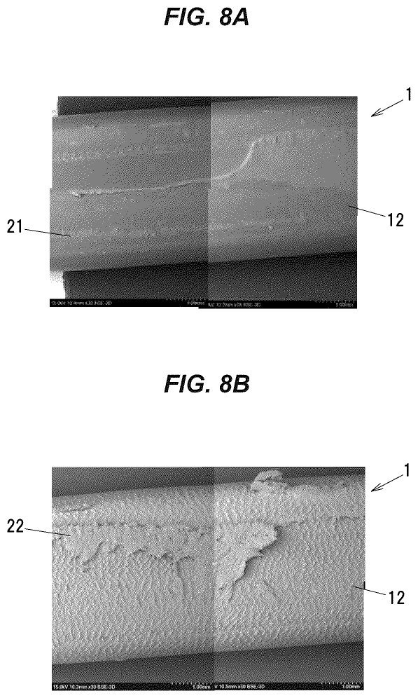

FIG. 8A is a scanning electron microscope (SEM) image of the surface of the sheath 12 after stripping the cable 1, which has an arithmetic mean height Sa of 1 μm, from the protector 40 made of ethylene-propylene rubber.

The SEM image in FIG. 8A shows that a small amount of the adhesive 21 remains on the surface of the sheath 12 when the interface delamination (delamination at the interface between the sheath 12 of the cable 1 and the cured adhesive) occurs.

The interface delamination in the peeling test of cable 1 shown in the SEM image in FIG. 8A is considered to be due to the arithmetic mean height Sa being small, which did not provide sufficient anchoring effect.

FIG. 8B is an SEM image of the surface of the sheath 12 after stripping the cable 1, which has an arithmetic mean height Sa of 10 μm on the surface of the sheath 12, from the protector 40 made of ethylene propylene rubber.

The SEM image in FIG. 8B shows that a part 22 of the protector 40 remaining on the surface of the cable 1 due to material fracture during peeling is present on the surface of the sheath 12.

The material failure in the peeling test of the cable 1 shown in the SEM image in FIG. 8B is considered to be due to the arithmetic mean height Sa being large enough to achieve a sufficient anchoring effect. In addition, the SEM image in FIG. 8B showed no evidence of peeling while the adhesive was uncured.

### Advantageous Effect of the Embodiment

According to the insulated wire of the present invention, by controlling the size of the wavy irregularities on the surface of the insulator made of thermoplastic polyurethane, a good bonding condition with high peeling strength can be obtained in a relatively short bonding time in adhesive bonding.

### SUMMARY OF THE EMBODIMENT

Next, the technical concepts that can be grasped from the above-described embodiment will be described with the help of the codes, etc. in the embodiment. However, each sign, etc. in the following description is not limited to the members, etc. specifically shown in the embodiment for the constituent elements in the scope of claims.

According to the first feature, an insulated wire 1 includes a linear conductor 10 insulative coated with an insulator 12 made of thermoplastic polyurethane as an outermost layer, and a plurality of wavy irregularities provided on a surface of the insulator 12 along a direction perpendicular to a longitudinal direction of the insulated wire 1, and an arithmetic mean height Sa of the surface of the insulator 12 is 4.4 μm or more and 12 μm or less.

According to the second feature, in the insulated wire 1 as described in the first feature, wherein the arithmetic mean height Sa is 5.8 μm or more.

According to the third feature, in the insulated wire 1 as described in the first feature, wherein the arithmetic mean height Sa is 10 μm or more.

According to the fourth feature, a structure 3 includes the insulated wire 1 as described in any one of the first to third features, and a component 40 made of ethylene propylene rubber, bonded to the surface of the insulator 12 of the insulated wire 1 by an adhesive 2.

The invention can be implemented in various modifications to the extent that it does not depart from the spirit thereof. The elements of the embodiment can be arbitrarily combined to the extent that the spirit of the invention is not departed from. The embodiment does not limit the inventions of the claims. It should be noted that not all of the combinations of features described in the embodiment are essential to the solution of the inventive problem.

1. An insulated wire, comprising:
a linear conductor insulative coated with an insulator comprising thermoplastic polyurethane as an outermost layer; and
a plurality of wavy irregularities provided on a surface of the insulator along a direction perpendicular to a longitudinal direction of the insulated wire,
wherein an arithmetic mean height Sa of the surface of the insulator is 4.4 μm or more and 12 μm or less.

2. The insulated wire, according to claim 1, wherein the arithmetic mean height Sa is 5.8 μm or more.

3. The insulated wire, according to claim 1, wherein the arithmetic mean height Sa is 10 μm or more.

4. A structure, comprising;
the insulated wire according to claim 1, and
a component comprising ethylene propylene rubber, bonded to the surface of the insulator of the insulated wire by an adhesive.

5. The structure, according to claim 4, wherein the arithmetic mean height Sa is 5.8 μm or more.

6. The structure, according to claim 4, wherein the arithmetic mean height Sa is 10 μm or more.
